(19) United States
(12) Patent Application Publication
(10) Pub. No.: US 2010/0161406 A1
(43) Pub. Date: Jun. 24, 2010

(54) Method and Apparatus for Managing Classes and Keywords and for Retrieving Advertisements

(75) Inventor: Venkat Narayan Vedam, Bangalore (IN)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/645,758

(22) Filed: Dec. 23, 2009

(30) Foreign Application Priority Data
Dec. 23, 2008 (IN) 2210/KOL/2008

(51) Int. Cl. G06Q 30/00; G06F 15/18; G06F 17/30

(52) U.S. Cl. 705/14.41; 706/12; 705/14.49; 707/737; 705/14.72; 707/E17.046

(57) ABSTRACT

A method and apparatus for managing classes and keywords and retrieving advertisements in a mobile station (110) is disclosed. A classifier (120) analyzes the user-consumed content being sent, received, or simply accessed locally by an application running on the mobile station and extracts key-phrases from the user-consumed content and classifies the key-phrases using the stored classes and keywords and fetches an advertisement from its local advertisement database (135) based on the class:keyword. When there is no relevant class, keyword, or advertisement found for the key-phrase, the classifier (120) updates a learning database (123) with the key-phrase. Then, upon receiving a trigger from an attribute unit (155), an association engine (150) reads the learning database (123) and extracts any stored key-phrases from the learning database (123). Based on the key-phrases, the association engine (150) requests the network (190) to provide data such as class, keywords, and advertisements.

### FIELD OF THE DISCLOSURE

The present disclosure relates generally to retrieving advertisements and, more particularly, to a technique for managing classes and keywords in a mobile station and for retrieving advertisements for the mobile station.

### BACKGROUND

In conventional systems, a mobile station in a network performs active content analysis on user-viewed content such as received broadcast content, browser content, streaming content, content in MMS and SMS messages, etc. to derive a lengthy set of keywords for every piece of content passing through the mobile station. The mobile station sends the lengthy set of keywords to the network and fetches advertisements from the network based on this lengthy set of keywords. First of all, this active processing of received content at the mobile station consumes significant processor time and battery energy. Second, transmitting the lengthy set of keywords for every piece of content passing through the mobile station to fetch related advertisements consumes a significant amount of over the air resources which results in current drain as well as billing for the user's data usage. Third, fetching advertisements from the network may result in a time delay in displaying the advertisement to a user of the mobile station relative to the user-viewed content.

Accordingly, there is an opportunity to develop a method and apparatus for managing keywords in the mobile station and retrieving and displaying advertisements.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a mobile station connected to a network in accordance with some embodiments.

FIG. 2 is a flowchart of a method for populating a class:keyword database and an advertisement database in a mobile station by a network in accordance with some embodiments.

FIG. 3 is a flowchart of a method for retrieving advertisements in a mobile station in accordance with some embodiments.

FIG. 4 is a flowchart of a method for managing a class:keyword database and an advertisement database in a mobile station by a network in accordance with some embodiments.

FIG. 5 is an example class:keyword database showing various classes and associated keywords in accordance with some embodiments.

FIG. 6 is an example advertisement database showing various advertisements for different classes and associated keywords in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Active processing of internet content to derive classes and keywords is performed at the network, and the classes and keywords with associated advertisements are transmitted to the mobile station by the network. These classes, keywords, and advertisements are stored in databases at the mobile station. An application (for example, SMS) receives user-consumed content at the mobile station either from the user or from a remote sender. The user-consumed content may be audio as well as visual. The mobile station extracts key-phrases from the user-consumed content and matches the extracted key-phrases to the classes and keywords stored at the mobile station. The mobile station further fetches an advertisement from its local database based on the class:keyword determination. In cases where there is no relevant class, keyword, or advertisement for the extracted key-phrase, the mobile station updates a learning database with the particular key-phrase. Then, upon receiving a trigger from a local attribute unit, the mobile station reads the learning database and extracts key-phrases from the learning database. Based on the key-phrases from the learning database, the mobile station requests the network for data (class, keyword, and/or advertisements). In response, the network updates the mobile station's local databases with the requested data.

By actively analyzing user-consumed content on a mobile station and presenting relevant advertisements from local storage on the mobile station, a user can see relevant advertisements with little time delay. If no relevant advertisements are currently available at the mobile station, the mobile station will present a generic advertisement and later fetch advertisements from the network in order to update the database of stored advertisements at the mobile station. For fetching advertisements, the mobile station uses the key-phrases from the learning database. Sending key-phrases rather than a lengthy set of keywords for every piece of content passing through the mobile station as used in the conventional system helps to reduce consumption of over the air resources and decreases billing for the user's data usage. Moreover, by not transmitting the lengthy set of keywords for every piece of content passing through the mobile station, a user's privacy may be enhanced.

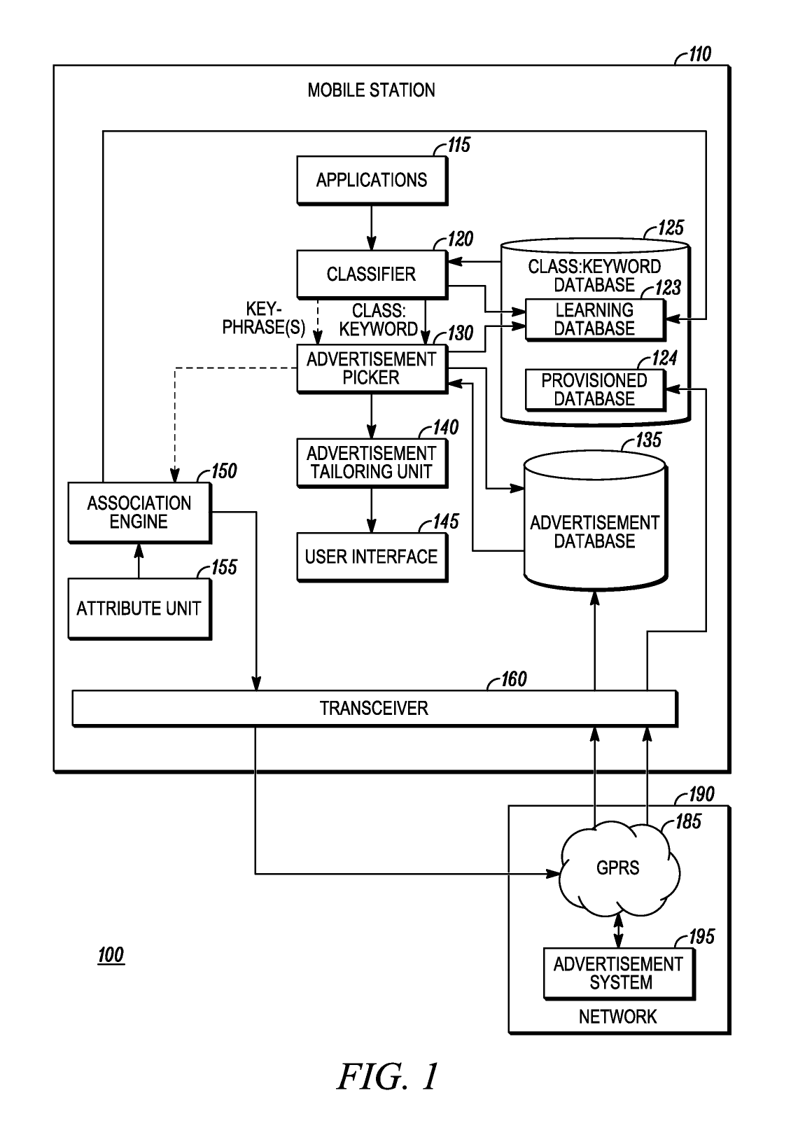

FIG. 1 is a block diagram 100 of a mobile station 110 connected to a network 190 in accordance with some embodiments. The mobile station 110 includes software applications 115, a classifier 120, an advertisement picker 130, an advertisement tailoring unit 140, a user interface 145, an association engine 150, an attribute unit 155, a transceiver 160, an advertisement database 135, and a class:keyword database 125 with a learning database 123 and a provisioned database 124.

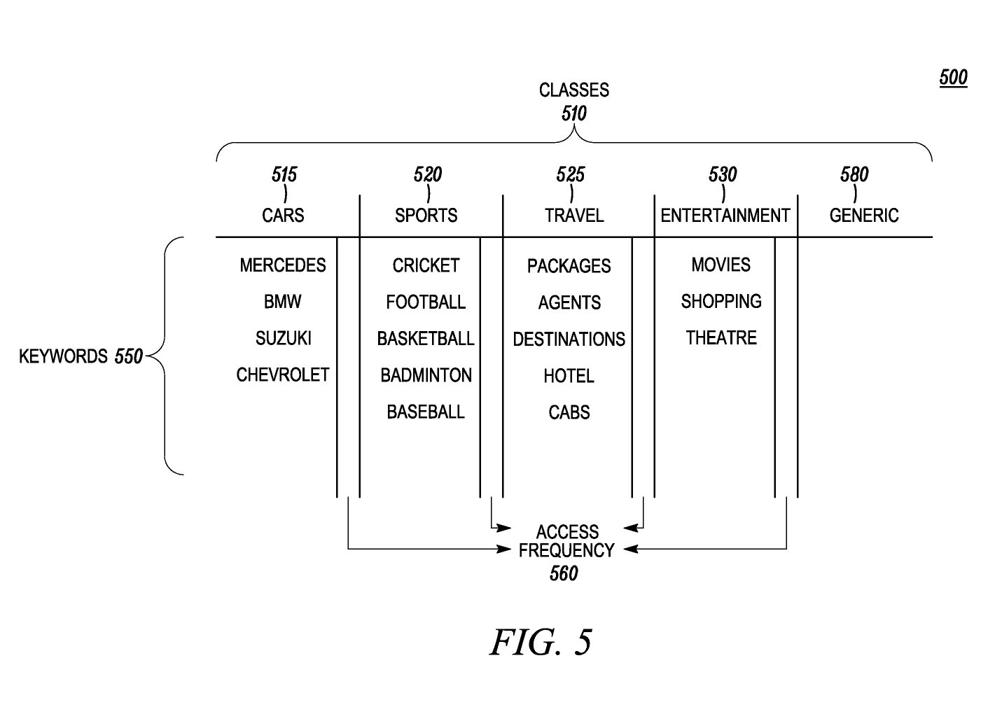

The provisioned database 124 stores various classes and associated keywords. Classes are broad subject matter areas where most advertising may be categorized. Keywords represent topics within each class that specifically cover a narrower subject matter area within the class. FIG. 5 is an example class:keyword database 500 showing various classes 510, their associated keywords 550, and an access frequency 560 for each class:keyword. An access frequency 560 parameter is associated with each keyword 550 for every class 510. The access frequency 560 for a particular class:keyword represents the number of times a particular class:keyword has been used.

In the example of FIG. 5, there are various classes 510 such as cars 515, sports 520, travel 525, entertainment 530, and generic 580. Each class 510 further includes a number of keywords 550. For example, the class sports 520 include keywords 550 such as cricket, football, basketball, badminton, and baseball. Similarly, the class travel 525 includes keywords 550 such as packages, agents, destinations, hotels, and cabs. The class cars 515 include keywords 550 such as Mercedes, BMW, Suzuki, and Chevrolet, and the class entertainment 530 includes keywords 550 such as movies, shopping, and theatre. In one example, there may be an additional class called “generic” 580 in the list of classes 510. In another example, each keyword 550 may further include various sub-keywords and so on. For example, the keyword 550 Mercedes in the class cars 515 may include sub-keywords such as Mercedes Benz C class, Mercedes Benz S class, and Mercedes Benz CS class.

We now return to FIG. 1 where, in one embodiment, initially the provisioned database 124 is populated by the network 190. The network (or an operator of the network) creates different classes. In one example, the network operator creates the classes based on the conceptual areas where the operator wants to advertise. In another example, the network operator creates the classes based on a user's potential (or actual) needs and interests.

After creating classes, the network may crawl various internet content sources, such as web sites, blogs, etc., to extract keywords and associate various keywords with each class. In one example, the network may apply Naïve-Bayes classification for associating keywords with classes. Now, the network operator associates advertisements with each class:keyword (such as for sports:cricket, sports:football, sports:basketball, and so on) and transmits the classes, keywords, and advertisements to the mobile station 110. The transceiver 160 in the mobile station receives the classes, keywords, and advertisements. The classes and keywords are further used to populate the provisioned database 124 and the advertisements are used to populate the advertisement database 135.

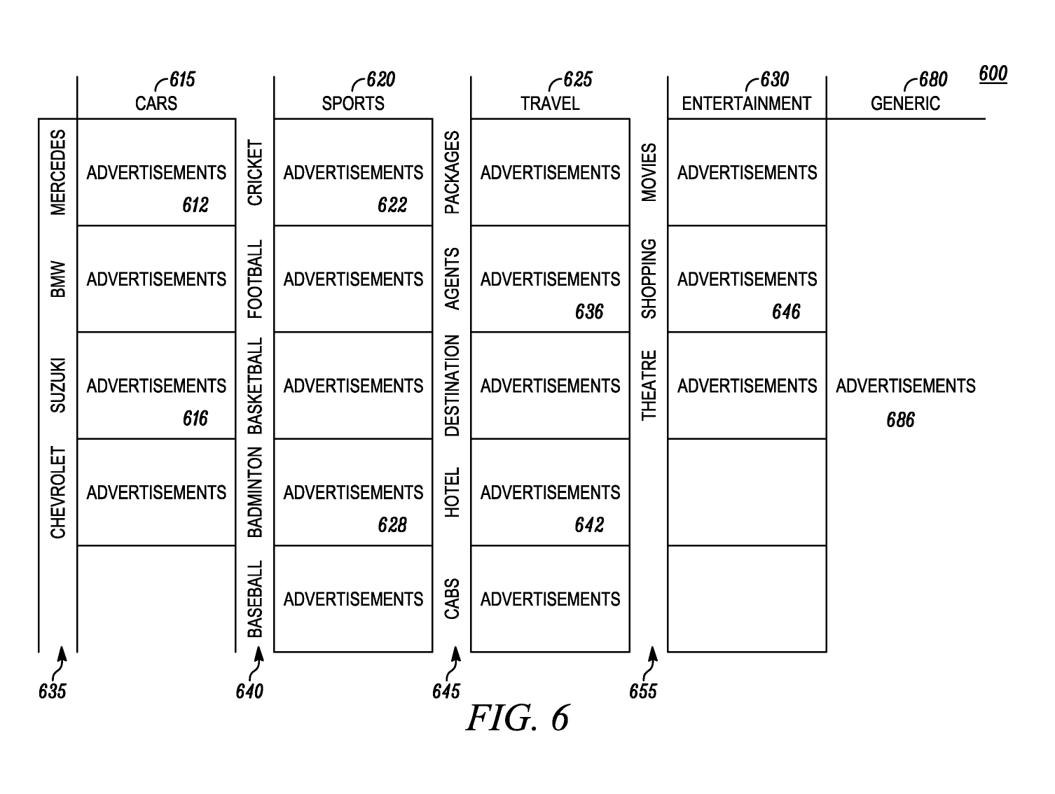

The advertisement database 135 stores advertisements for different class:keywords. FIG. 6 is an example advertisement database 600 showing an organization structure for various advertisements for different classes 615, 620, 625, 630, 680 and associated keywords 635, 640, 645, 655. In the example of FIG. 6, the advertisement database stores advertisements for each keyword 635, 640, 645, 655 of every non-generic class 615, 620, 625, 630. FIG. 6 shows different classes such as cars 615 has advertising associated with keywords 635 such as Mercedes, BMW, Suzuki, and Chevrolet; class sports 620 has advertising associated with keywords 640 such as cricket, football, basketball, badminton, and baseball; class travel 625 has advertising associated with keywords 645 such as packages, agents, destinations, hotels, and cabs; and class entertainment 630 has advertising associated with keywords 655 such as movies, shopping, and theatre. For example, the advertisement database 600 stores advertisements 612 for class cars 615 and keyword 635 Mercedes. Similarly, there are advertisement storage areas 616, 622, 628, 636, 642, 646 for cars:Suzuki, sports:cricket, sports:badminton, travel:agents, travel:hotels, and entertainment:shopping respectively. In one example, the advertisement database 600 may also include a generic class 680 that further includes advertisements 686 that are not categorized with any other classes and keywords available in the advertisement database.

Referring back to FIG. 1, in an alternate embodiment, the provisioned database 124 and the advertisement database 135 are initially populated by a distributor of the mobile station 110. The distributor of the mobile station creates different classes, associates keywords, and obtains advertisements based on the areas that the distributor wants to advertise or based on a prospective user's needs or interests. In another embodiment, the provisioned database 124 and the advertisement database 135 are initially populated by the network 190 as well as by the distributor of the mobile station 110. Thus, the provisioned database 124 and advertisement database 135 have initial entries that are used initially and later tailored to user-consumed content on the user's mobile station. Note user-consumed content can include both networked and non-networked content. For example, user-consumed non-networked content includes “notes” and “address book” applications.

The applications 115 that help determine user-consumed content may include broadcast applications, browser applications, SMS, MMS, chats, ring tones, wall papers, notes, and address book for the mobile station 110. The function of the applications 115 is to register user-consumed content with the classifier 120. The classifier 120 analyses the content and extracts key-phrases from the user-consumed content. The application used to register user-consumed content changes depending upon what applications are active on the mobile station. Thus, the classifier 120 has a holistic perspective, not limited to a particular application.

In one example, the application 115 may be SMS, and the SMS application 115 registers user-consumed content (such as, words in a received message “we need another bowler for tonight's game”) with the classifier 120. The classifier 120 analyzes the content and extracts the key-phrases “bowler” and “game” from the content. Now, the classifier classifies the extracted key-phrases (for example, bowler and game) using available class:keyword combinations present in the provisioned database 124. Please note that the provisioned database 124 is limited to a fixed size due to memory size constraints of the mobile station 110. In other words, the provisioned database 124 can only hold a limited number of classes and keywords. Therefore, the classifier 120 can match the extracted key-phrases only to a limited number of classes and keywords from the provisioned database which, subsequently, limits processor drain.

Referring back to the example of FIG. 5, the classifier 120 compares the extracted key-phrases (for example, bowler and game) with different classes 515, 520, 525, 530, 580 and associated keywords available in the database 124, 500. In this example, the classifier 120 classifies “bowler” and “game” into class 510 sports 520 and keyword 550 cricket (sports: cricket). Note that if sports:bowling was available, the classifier might have selected sports:bowling over sports:cricket based on the access frequency 560 values of the two potential classifications.

In another example, if the extracted key-phrase is “tennis,” the classifier 120 will classify the extracted key-phrase with class “sports” only, as none of the keywords relates to the extracted key-phrase “tennis.” In yet another example, if the extracted key-phrase is “flowers,” then the classifier will not be able to match “flowers” with any of the classes or keywords from FIG. 5. In such a scenario, the classifier 120 will classify the extracted key-phrase with class “generic” 580. In the above examples, when the classifier 120 does not find a match between the extracted key-phrases and any of the classes and keywords from the provisioned database 124, the classifier 120 updates the learning database 123 with the extracted key-phrases. In the above examples, the classifier 120 will update the learning database 123 with key-phrases “tennis” and “flowers.”

The classifier 120 updates the learning database 123 with extracted key-phrases that do not match the available class:keywords so that the mobile station 110 can request data (such as classes, keywords, and advertisements) related to the extracted key-phrases from the network 190 at a later stage and can update the databases 125, 135.

In another embodiment, when the classifier 120 does not find an exact match between the extracted key-phrases and the available class:keywords from the provisioned database 124, then the classifier 120 updates the learning database 123 as well as the provisioned database 124 with the extracted key-phrases. In the above example, when the extracted key-phrase is “tennis,” then the classifier 120 may add “tennis” as a keyword to the class sports 520 (as shown in FIG. 5) and when the extracted key-phrase is “flowers,” then the classifier 120 may add “flowers” as a new class in the provisioned database 124. As a result, the classifier 120 dynamically updates classes and keywords in the provisioned database 124.

After classifying the extracted key-phrases with the available class:keywords from the provisioned database 124, the classifier 120 sends the selected class:keyword to the advertisement picker 130. Optionally, the classifier 120 may send the extracted key-phrases to the advertisement picker 130 along with the selected class:keyword. Please note that when there is no match found between the extracted key-phrases and the available class:keywords in the provisioned database 124, then the classifier 120 sends the class “generic” to the advertisement picker 130. Note that a class can be sent without a keyword (for example, sports:[nil]).

The advertisement picker 130, based on the received class:keyword, selects advertisements from the advertisement database 135. In one example, if the class:keyword received by the advertisement picker is sports:cricket, then referring back to the example of FIG. 6, the advertisement picker 130 picks an advertisement stored in the storage area 622. In another example, if the class:keyword received by the advertisement picker is only sports (without a keyword), then referring back to the example of FIG. 6, the advertisement picker 130 may pick any advertisement belonging to the class sports 620 and any of the keywords (such as, cricket, football, basketball, badminton, or baseball). In other words, when the advertisement picker 130 only receives a class and not a keyword, then the advertisement picker may pick any advertisement belonging to that class and any of its associated keywords.

In yet another example, if the class:keyword received by the advertisement picker 130 is “generic”, then referring back to the example of FIG. 6, the advertisement picker 130 picks an advertisement from the generic advertisement storage area 686. Alternatively, if the class:keyword received by the advertisement picker 130 is “generic”, then referring back to the example of FIG. 6, the advertisement picker 130 may pick any advertisement from the advertisement database 600.

In one scenario, it is possible that the advertisement picker 130 receives a class:keyword (for example, sports:cricket) from the classifier 120 and when the advertisement picker 130 tries to pick advertisements associated with the received class:keyword, it may find out that the advertisement database 135 does not have any advertisements for the particular class:keyword (for example, sports:cricket) in the appropriate advertisement storage area 622. In such a scenario, the advertisement picker may pick any advertisement belonging to that class and any of the associated keywords that have advertisements in storage (for example, sports:baseball). In such a scenario, the advertisement picker 130 updates the learning database 123 with information indicating that no relevant advertisement is found for sports:cricket. In one example, the advertisement picker 130 may also inform the association engine 150 that no relevant advertisement is found for a particular class:keyword.

In an example, where the advertisement picker 130 only receives the class:keyword from the classifier and does not receive the extracted key-phrases, the advertisement picker 130 selects an advertisement from the advertisement database 135 based on the received class:keyword. In one case, if the storage area for the received class:keyword does not have any advertisements, then the advertisement picker 130 updates the learning database 123 with information indicating that there are no relevant advertisements found in the advertisement database 600 for the received class:keyword. In another case, the advertisement picker may update 380 the learning database with information indicating that no relevant advertisement is found for a particular class:keyword, if the selected advertisement is stale based on the time elapsed since present time and when the advertisement was stored in the advertisement database, etc.

In a first example, where the advertisement picker 130 receives the extracted key-phrases along with the class:keyword from the classifier 120, the advertisement picker 130 selects advertisements from the advertisement database 135 based on the received class:keyword and the received extracted key-phrases. For example, the advertisement picker 130 receives a class:keyword (for example, sports:cricket) and the extracted key-phrases “bowler” and “game” from the classifier 120. Now, the advertisement picker 130 picks an advertisement from the storage area 622 based on the received key-phrases. Therefore, an advertisement that belongs to the storage area 622 and includes the phrases “bowler” and “game” in the advertisement has the highest probability of getting picked by the advertisement picker 130.

Moreover, if there are multiple advertisements in the storage area 622 that include the phrases “bowler” and “game,” then the selection of an advertisement from multiple advertisements fulfilling the criteria may depend on the number of times an advertisement has been already picked, how recently an advertisement was viewed, when the advertisement was loaded into the advertisement database, and/or many other factors. After picking an advertisement, the advertisement picker 130 checks for the relevance of the advertisement relative to the extracted key-phrases. Relevance can be determined through matches between the advertisement (content or meta-data) and the extracted key-phrases. If the advertisement picker 130 determines that the advertisement selected has low relevance, then the advertisement picker 130 updates the learning database 123 with information indicating that only a low relevance advertisement was found for a particular class:keyword and key-phrase.

In a second example, the advertisement picker 130 does not find any advertisement in the storage area 622 including both the key-phrases “bowler” and “game” but finds an advertisement in the storage area 622 including the phrase “game.” After picking the advertisement, the advertisement picker 130 checks for the relevance of the advertisement relative to the extracted key-phrases. In this example, the advertisement picker 130 infers that the selected advertisement has medium relevance relative to the extracted key-phrases and sends it to the advertisement tailoring unit 140. Subsequently, the advertisement picker 130 also updates the learning database 123 with information indicating that there are no relevant advertisements found in the advertisement database 600 for key-phrase “bowler.”

In a third example, if the advertisement picker 130 does not find any advertisement in the storage area 622 including either “bowler” or “game,” then the advertisement picker 130 picks any advertisement from the storage area 622. After picking the advertisement, the advertisement picker 130 checks for the relevance of the advertisement relative to the extracted key-phrases. In this example, the advertisement picker infers that the advertisement has low relevance relative to the extracted key-phrases and sends it to the advertisement tailoring unit 140. Subsequently, the advertisement picker 130 also updates the learning database 123 with information indicating the low relevance of advertisements found in the advertisement database 600 for key-phrases “bowler” and “game.”

Selection of an advertisement may depend on the number of times an advertisement has been already picked. Selection could also depend on how recently an advertisement was viewed, when the advertisement was loaded into the advertisement database, and/or many other factors.

After picking an advertisement, the advertisement picker 130 sends the advertisement to the advertisement tailoring unit 140. The advertisement tailoring unit 140 processes the audio, visual, and text of an advertisement based on the user interface available and application running and sends it to the user interface 145. For example, if the advertisement is an SMS then it will only include text and if the advertisement is an MMS then it may include text, sound, and an icon. The user interface 145 may include a speaker and/or a display. The user interface 145 presents the advertisement to the user of the mobile station 110 along with the user-consumed content.

The association engine 150 functions in the background and is responsible for using the transceiver 160 to request the network 190 for classes, keywords, and advertisements upon receiving a trigger from the attribute unit 155. The transceiver 160 is responsible for transmitting data from the mobile station 110 to the network 190 and for receiving data from the network 190 for the mobile station 110.

The attribute unit 155 tracks factors such as location of the mobile station, mobile station roaming, time of day, advertisement presented N-times, class expired, keyword expired, and so on. In one example, if a location of the mobile station 110 changes, then the attribute unit 155 triggers the association engine 150. In another example, if the time of the day is 10:00 pm, then the attribute unit 155 triggers the association engine. Optionally, the attribute unit 155 may also track qualifiers as a factor. Qualifiers are predefined advertising features and may be coupons, percentage discounts, free offers, etc. When the attribute unit 155 triggers the association engine 150, it also informs the association engine 150 about any qualifiers set by the user of mobile station, distributor, or manufacturer. For example, if a user of the mobile station chooses free offers as a required qualifier, then the attribute unit 155 also informs the association engine 150 to fetch only advertisements from the network 190 that include free offers.

Upon receiving a trigger from the attribute unit 155, the association engine 150 reads the learning database 123 and extracts the key-phrases stored in the learning database. Based on the extracted key-phrase, the association engine 150 requests the network 190 for classes, keywords, and/or advertisements using the transceiver 160.

In one example, if the association engine 150 reads the learning database 123 and extracts the key-phrase “flowers” then the association engine 150 may request the network 190 for classes, keywords, and advertisements associated with flowers. In return, the network 190 may update the provisioned database 124 with class flowers and keywords lily, rose, and lotus. The network 190 may also update the advertisement database 135 with advertisements for new storage areas flowers:lily, flowers:rose, and flowers:lotus.

In another example, if the association engine 150 reads the learning database 123 and extracts the key-phrase “tennis” then the association engine 150 may request the network 190 for keywords and advertisements associated with tennis. In one scenario, the network 190 may update the class sports in the provisioned database 124 with keyword tennis and may also update the advertisement database 135 with advertisements for a new storage area sports:tennis. In another scenario, when the classifier 120 has already updated the class sports in the provisioned database 124 with the keyword “tennis,” then the association engine 150 may request the network 190 for advertisements associated with “tennis” and the network 190 may only update the advertisement database 135 with advertisements for a new storage area sports:tennis.

In yet another example, if the association engine 150 reads the learning database 123 and extracts the key-phrase “bowler” and “game” suggesting that there are no relevant advertisements found in the existing storage area sports:cricket, then the association engine 150 may request the network 190 for advertisements for sports:cricket. In return, the network 190 may update the advertisement database 135 with new advertisements for the existing storage area sports:cricket or add sub-keyword bowler to the keyword cricket and add advertisements with endorsements by famous bowlers.

Please note that the mobile station advertisement database 135 is limited. Therefore, obtaining new advertisements may entail deleting old advertisements from the advertisement database 135. In one example, if advertisements related to “cars” are not accessed for a predefined number of days, then the mobile station may delete all or most of the advertisements for the storage area for class cars and all its associated keywords. In another example, if an advertisement is presented to a user a predefined number of times, then the mobile station may delete that advertisement so as to avoid overexposure to that advertisement.

The network example 190 includes GPRS 185 (General Packet Radio Service) and an advertisement system 195. The GPRS 185 updates the mobile station databases 125, 135 with classes, keywords, and advertisements using the transceiver 160. The GRPS 185 also includes components responsible for creating classes and associating keywords with classes. The GPRS 185 is further connected to the advertisement system 195. The advertisement system 195 stores advertisements for different classes and keywords, and sends them to the mobile station 110 through the GPRS 185. The advertisement system 195 may be connected directly or indirectly to companies seeking to advertise, advertising agencies, etc.

As a result of creating classes and keywords by the network, the mobile station uses no processor resources for this purpose. Moreover, by storing the advertisements at the mobile station, there is no noticeable time delay in presenting an advertisement to the user of the mobile station (when the user-consumed content is presented). Also, by requesting particular classes, keywords, and advertisements by the mobile station from the network, the databases at the mobile station are updated every time a trigger from the attribute unit 155 is received. This also allows the advertisement database 135 to be tailored to subjects of interest to the user as expressed through user-consumed content sent from the mobile station, received by the mobile station, or simply accessed locally by the mobile station. Moreover, the advertisement database 135 continues to be tailored based on user response to an advertisement (for example, clicking or going to URL, using coupons, etc.). Also, by updating the advertisement database 135 in the background or at night, the user's content reception experience is not impacted (i.e., the mobile station does not receive content as well as the advertisements over the air; it only receives content over the air and advertisements locally).

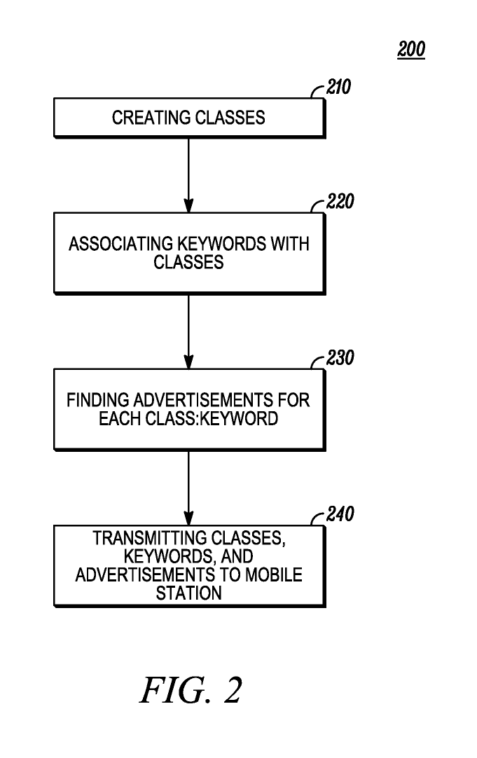

FIG. 2 is a flowchart 200 of a method of populating a class:keyword database and an advertisement database in a mobile station in accordance with some embodiments. The method starts when the network (such as the network 190 shown in FIG. 1) or an operator of the network creates 210 classes. In one example, the network operator creates the classes based on the areas that the operator wants to advertise. In another example, the network operator creates the classes based on a prospective user's needs or interests.

After creating 210 classes, the network operator may crawl internet content sources such as various web sites, blogs, etc. to extract keywords for all the classes. The network operator then associates 220 the extracted keywords with their respective class. In one example, the network operator may apply Naïve-Bayes classification for associating keywords with classes. Alternately or additionally, the network operator may simply assign keywords to classes. Now, the network operator finds 230 advertisements for each class:keyword (such as for sports:cricket, sports:football, sports:basketball shown in FIG. 5) and transmits 240 the classes, keywords, and advertisements to the mobile station. In one example, the network may broadcast or multicast the classes, keywords, and advertisements to a group of mobile stations. Alternately, the network operator may program the databases at time of manufacture of mobile station or distribution of mobile station. Note that the mobile station's databases are limited to a fixed size due to memory size constraints of the mobile station. Therefore, a provisioned database can only hold a limited number of classes and keywords and an advertisement database can only hold a limited number of advertisements.

As a result of creating classes and keywords by the network, the mobile station avoids spending time, energy, and resources for this purpose. The initial classes, keywords, and advertisements are now available at the mobile station locally and can be further tailored based on the content activities of the mobile station.

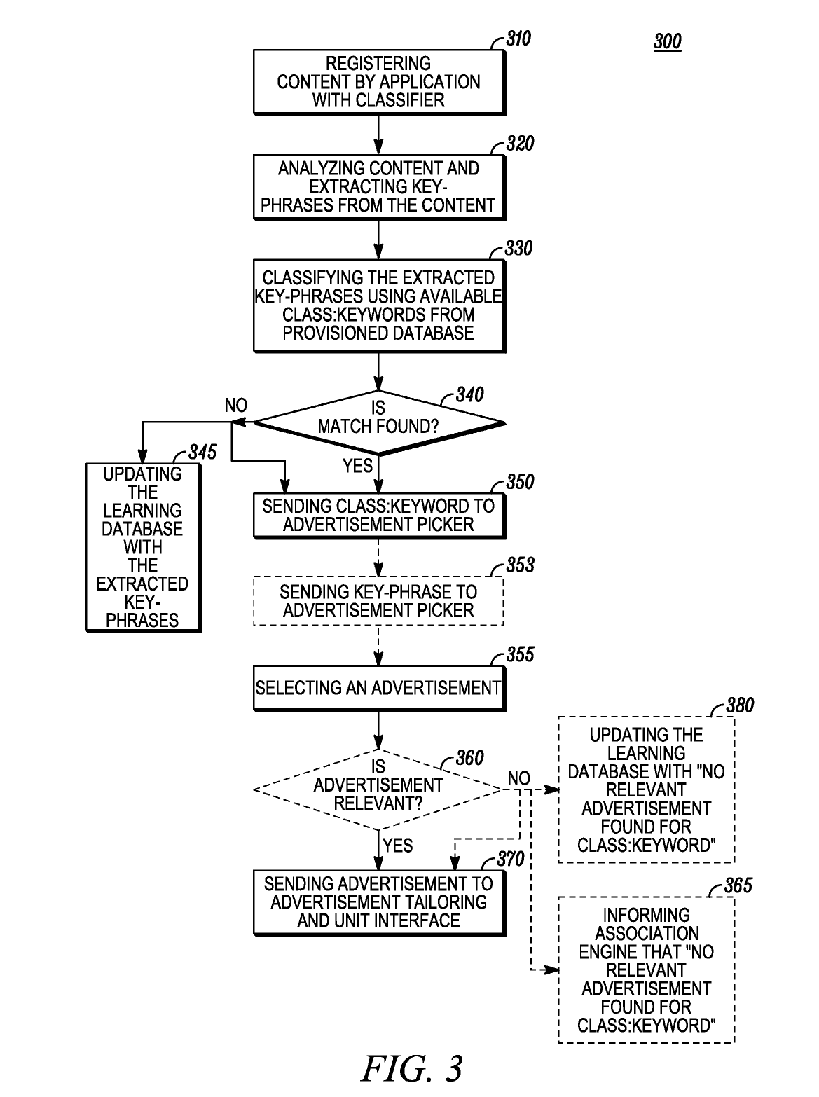

FIG. 3 is a flowchart 300 of a method for retrieving advertisements in a mobile station in accordance with some embodiments. The method starts with an application (such as the applications 115 shown in FIG. 1) registering 310 content with a classifier (such as the classifier 120 shown in FIG. 1). The classifier analyses 320 the user-consumed content and extracts 320 key-phrases from the user-consumed content.

In one example, the application may be SMS and the applications registers 310 user-consumed content (such as, text from a message “want to go see the wolves on ice?”) with the classifier, the classifier analyses the content and extract 320 the key-phrases “wolves” and “ice” from the content.

After extracting 320 one or more key-phrases from the user-consumed content, the classifier classifies 330 the extracted key-phrases (for example, wolves and ice) according to the available class:keywords present in the provisioned database (such as provisioned database 124 shown in FIG. 1). In the above example, the provisioned database includes classes:keywords such as those shown in FIG. 5. Moreover, the access frequency (i.e., the number of times a particular class:keyword is earlier used) of class sports 520 is higher than the frequency of class travel 525. Subsequently, the classifier 120 will classify the extracted key-phrases “wolves” and “ice” with class:keyword sports:[nil]. For a different user, the provisioned database may include different class:keywords and/or different access frequencies for the classes. For example, if the class entertainment has the highest access frequency and the class travel has the next highest access frequency, then the classifier 120 may classify the extracted key-phrase “wolves” and ice” for the same SMS message with class:keyword travel: destinations.

After classifying 330, the classifier determines 340 if a match is found between the extracted key-phrase and the available class:keywords present in the provisioned database. There are different cases possible as a result of determining.

In a first case, the classifier may find an exact match between the extracted key-phrase and an available class:keyword present in the provisioned database. Referring back to the example of FIG. 5, the classifier classifies the extracted key-phrase (for example, wolves and ice) with different classes 515, 520, 525, 530, 580 and associated keywords available in the database 124. In this example, the classifier classifies “wolves” and “ice” with class 510 travel 525 and keyword 550 destinations (travel:destinations). In this case, when an exact match is found then the classifier sends 350 the class:keyword (travel:destinations) to an advertisement picker (such as the advertisement picker 130 shown in FIG. 1).

In a second case, the classifier may not find an exact match between the extracted key-phrase and the available class:keywords present in the provisioned database. Referring back to the example of FIG. 5, if the extracted key-phrases are “wolves” and “ice,” the classifier may classify the extracted key-phrase with class “sports” only, because the extracted key-phrases indicate an American hockey league team and none of the sports keywords matches a hockey concept. In this case, when an exact match is not found then the classifier sends 350 the class:keyword sports:[nil] to an advertisement picker and also updates 345 the learning database (such as the learning database 123 shown in FIG. 1) with the extracted key-phrase. In the above example, the classifier updates the learning database 123 with key-phrases “wolves” and “ice.” Additionally, when the classifier does not find a match between the extracted key-phrase(s) and the class:keywords from the provisioned database, then the classifier may also update the provisioned database with the extracted key-phrase. In the above example, when the extracted key-phrase is “wolves” and “ice” then the classifier may add “hockey” as a keyword to the class sports 520 (FIG. 5).

In a third case, the classifier may not find any match between the extracted key-phrase(s) and the available class:keywords present in the provisioned database. Referring back to the example of FIG. 5, if the extracted key-phrases are “omelette” and “recipe,” then the classifier will not be able to classify “omelette” and “recipe” with any of the classes or keywords from the database shown in FIG. 5. In such scenario, the classifier classifies the extracted key-phrase with class “generic.” In this case, when no match is found then the classifier sends 350 the class:keyword generic to an advertisement picker and also updates 345 the learning database with the extracted key-phrase. In the above example, the classifier updates the learning database with key-phrases “omelette” and “recipe.” Additionally, when the classifier does not find any match between the extracted key-phrase and the class:keywords from the provisioned database, then the classifier may also update the provisioned database with the extracted key-phrase. In this example, “omelette” and “recipe” are ambiguous and could be related to restaurant:breakfast or entertainment:shopping (sub-keyword “bookstore”), so no new class:keyword is added to the provisioned database at this time. Alternately, more than one class:keyword could be added to provisioned database.

As mentioned previously, after classifying 330 the extracted key-phrase with the available class:keywords from the provisioned database, the classifier sends 350 the class:keyword to the advertisement picker. The advertisement picker, based on the received class:keyword, selects 355 an advertisement from an advertisement database. In one example, if there are no advertisements available in the sent class:keyword storage area, then the advertisement picker updates 380 the learning database with information indicating that no relevant advertisement is found for a particular class:keyword. In another example, the advertisement picker may updates 380 the learning database with information indicating that no relevant advertisement is found for a particular class:keyword, if the selected advertisement is stale based on the time elapsed since present time and when the advertisement was stored in the advertisement database, etc.

Optionally, the classifier may also send 353 the extracted key-phrases to the advertisement picker along with the class:keyword. In this scenario, the advertisement picker, based on the received class:keyword and the received key-phrases, selects 355 an advertisement from an advertisement database and checks if the selected advertisement is relevant 360 relative to the extracted key-phrase. If the advertisement picker determines that the advertisement is not relevant, then the advertisement picker updates 380 the learning database with the extracted key-phrases. In this example, the advertisement picker may determine that the relevance is low, if the selected advertisement does not include one or more of the extracted key-phrases received from the classifier.

In addition to determining relevance based on an informational “phrase-based” match between the content of an advertisement (or an advertisement's meta-data) and extracted key-phrases, relevance can also be affected by factors such as quantity of advertisements, the upload time and date of advertisements, whether the advertisement has been clicked-upon, how many times the advertisement has previously been picked, and other factors. In an embodiment, the advertisement picker may also inform 365 the association engine that no relevant advertisement is found for a particular class:keyword.

In any case, the advertisement picker sends 370 the advertisement to an advertisement tailoring unit. The advertisement tailoring unit processes the audio, visual, and text of an advertisement based on the user interface available and application running and sends it to the user interface. For example, if the advertisement is an SMS then it will only include text and if the advertisement is an MMS then it may include text, sound, and icons. The advertisement tailoring unit processes the advertisement and sends 370 it to the user interface. The user interface may be a speaker and/or a display. The user interface presents the advertisement to the user of the mobile station.

As a result of retrieving advertisements from the database at the mobile station, there is little time delay in presenting an advertisement to the user of the mobile station. Also, by requesting particular classes, keywords, and advertisements by the mobile station from the network, the databases at the mobile station are updated every time a trigger from an attribute unit is received. Thus, an advertisement is always sent to the user interface regardless of relevance. Moreover, the classes and keywords from the learning database are much fewer compared to the lengthy set of keywords for every piece of content passing through the mobile station used in the conventional system. This helps to reduce over the air bandwidth and billing for the user's data usage. Moreover, by not transmitting the lengthy set of keywords for every piece of content passing through the mobile station, user privacy may be enhanced. If no class:keyword match is found or if the relevance of a selected advertisement is low, then the learning database has information with which to find advertisements more relevant to a user's consumed content.

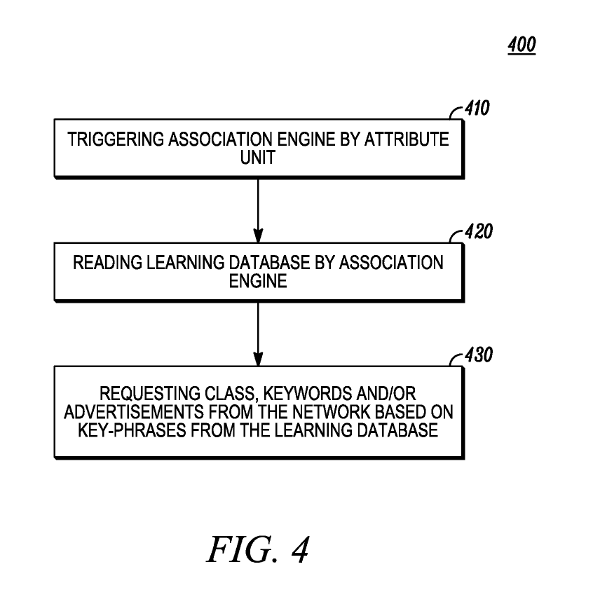

FIG. 4 is a flowchart 400 of a method for managing a class:keyword database and an advertisement database in a mobile station by a network in accordance with some embodiments. The method starts when an attribute unit (such as the attribute unit 155 shown in FIG. 1) triggers 410 an association engine (such as the association engine 150 shown in FIG. 1). The attribute unit may track whether a location of the mobile station has changed, when the mobile station is roaming, time of day, advertisement presented N-times, class expired, keyword expired, and so on. In one example, if a location of the mobile station changes outside a pre-defined region, then the attribute unit triggers the association engine. In another example, if the time of the day is 10:00 pm, then the attribute unit triggers the association engine.

Upon receiving a trigger from the attribute unit, the association engine reads 420 the learning database and extracts key-phrases from the learning database. Based on the extracted key-phrases, the association engine requests 430 the network (such as the network 190 shown in FIG. 1) for classes, keywords and/or advertisements.

In one example, if the association engine reads 420 the learning database and extracts the key-phrases “wolves” and “ice”. Then the association engine may request 430 the network for classes, keywords, and advertisements associated with the American hockey league. In return, the network may update the provisioned database class sports with keyword hockey. The network may also update the advertisement database with fresh advertisements for sports including sports:hockey.

In another example, if the association engine reads 420 the learning database and extracts the key-phrase “final four” during the month of March, then the association engine may request 430 the network for keywords and advertisements associated with basketball and a new sub-keyword NCAA. In one scenario, the network may update the class sports in the provisioned database with keyword basketball-NCAA and may also update the advertisement database with advertisements for sports:basketball-NCAA. In another scenario, when the classifier has already updated the class sports in the provisioned database with the keyword “basketball” and sub-keyword “NCAA,” then the association engine may request the network for advertisements associated with basketball-NCAA and the network may only update the advertisement database with advertisements for sports:basketball-NCAA.

In yet another example, if the association engine reads 420 the learning database and extracts the key-phrase suggesting that there are no relevant advertisements found for sports:cricket, then the association engine may request 430 the network for advertisements for sports:cricket. In return, the network may only update the advertisement database with advertisements for sports:cricket.

In another example, if the association engine reads 420 the learning database and realizes that the learning database is empty, then the association engine may request 430 the network to refresh the advertisement database and the class:keyword database based on the number of times an advertisement is presented to the user, successful click-through, stale advertisements, non-use of certain class:keywords and sub-keywords, “push” by advertising partners/programs of the network operator, etc. In return, the network updates the advertisement database and the class:keyword database of the mobile station.

As a result of requesting particular classes, keywords, and advertisements by the mobile station from the network, the databases at the mobile station are updated based on each user's needs and interests every time a trigger from the attribute unit is received. Therefore, the class cars and all its associated keywords may be completely removed from a particular user's database, whereas another user may have the class cars, keyword Mercedes and its sub-keywords completely full and updated.

Therefore, by using a classifier and class:keyword approach, the processing requirements at the mobile station are reduced. By using a local advertisement database and an advertisement picker, the speed of presenting mostly relevant advertisements to a user of the mobile station is improved. And by using a learning database and an association engine, the local advertisement database and the local class:keyword database can be tailored according to the interest of the mobile station's user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for a mobile station in a network for managing classes and keywords and retrieving advertisements, the method comprising:
receiving, by the mobile station, a class:keyword and an advertisement;
registering, by an application of the mobile station, user-consumed content with a classifier;
analyzing, by the classifier of the mobile station, the user-consumed content;
extracting, by the classifier, at least a key-phrase from the user-consumed content;
classifying, by the classifier, the key-phrase with at least an available class:keyword from a provisioned database;
checking, by the classifier, if a match is found between the key-phrase and the available class:keyword;
updating a learning database of the mobile station with the key-phrase, if no match is found;
receiving, by an association engine of the mobile station, a trigger from an attribute unit;
reading, by the association engine, the learning database to extract the key-phrase from the learning database, as a result of receiving the trigger; and
requesting, by the association engine, the network for data based on the key-phrase.

2. The method of claim 1, wherein the data includes at least a class, a keyword, or an advertisement.

3. The method of claim 1, wherein receiving further comprises:
storing the received class:keyword in the provisioned database of the mobile station; and
storing the received advertisement in an advertisement database of the mobile station.

4. The method of claim 1 further comprising:
updating, by the classifier, the provisioned database with the key-phrase, if no match is found.

5. The method of claim 1 further comprising:
sending, by the classifier, the class:keyword to an advertisement picker of the mobile station.

6. The method of claim 5 further comprising:
sending, by the classifier, the extracted key-phrase to the advertisement picker.

7. The method of claim 6 further comprising:
retrieving, by the advertisement picker, at least an available advertisement from an advertisement database based on the class:keyword;
presenting, by the advertisement picker, the available advertisement on the mobile station.

8. The method of claim 7, wherein displaying further comprises:
sending, by the advertisement picker, the available advertisement to an advertisement tailoring unit of the mobile station to format the advertisement based on the application of the mobile station; and
sending, by the advertisement tailoring unit, the available advertisement to a user interface of the mobile station.

9. The method of claim 7 further comprising:
retrieving, by the advertisement picker, at least an available advertisement from an advertisement database based on the extracted key-phase;
determining, by the advertisement picker, if the available advertisement is relevant to the extracted key-phrase; and
updating, by the advertisement picker, the learning database with the key-phrase, if the available advertisement is not relevant.

10. The method of claim 7 further comprising:
informing, by the advertisement picker, the association engine, if the available advertisement is not relevant.

11. The method of claim 1 further comprising:
creating, by the network, at least a class;
associating, by the network, at least a keyword with the class to form the class:keyword;
finding, by the network, at least an advertisement for the class:keyword; and
transmitting, by the network, the class:keyword and the advertisement to the mobile station, before the receiving.

12. The method of claim 1, wherein receiving further comprises:
storing, by a distributor of the mobile station, at least the class:keyword in the provisioned database of the mobile station; and
storing, by the distributor of the mobile station, at least the advertisement for the class:keyword in an advertisement database of the mobile station.

13. The method of claim 1 further comprising:
updating, by the network, at least the provisioned database of the mobile station or an advertisement database of the mobile station with the data.

14. The method of claim 1, wherein the attribute unit sends the trigger to the association engine when at least: a location of the mobile station changed, mobile station roaming, time of day changed, advertisement presented N-times, class expired, keyword expired, or no relevant advertisement found.

15. A mobile station in a network for managing classes and keywords and retrieving advertisements, the mobile station comprising:
an application, coupled to a classifier, for registering user-consumed content with the classifier;
the classifier for analyzing the user-consumed content, extracting at least a key-phrase from the user-consumed content, classifying the key-phrase with at least an available class:keyword from a provisioned database, checking if a match is found between the key-phrase and the available class:keyword from the provisioned database, and updating a learning database with the key-phrase if no match is found, wherein the learning database and the provisioned database are in the mobile station;
an attribute unit, coupled to an association engine, for triggering the association engine; and
the association engine, coupled to the learning database, for reading the learning database upon being triggered to extract the key-phrase from the learning database and for requesting the network for data based on the key-phrase, wherein the data includes at least a class, a keyword, or an advertisement.

16. The mobile station of claim 15 further comprising:
an advertisement picker, coupled to the classifier, for receiving the class:keyword from the classifier and retrieving at least an advertisement from an advertisement database based on the class:keyword, wherein the advertisement database is present in the mobile station.

17. The mobile station of claim 16 further comprising:
a user interface, coupled to the advertisement picker, for presenting the user-consumed content and the available advertisement on the mobile station.

18. The mobile station of claim 16 wherein the advertisement picker receives the key-phrase from the classifier and determines if the available advertisement is relevant to the key-phrase.

19. The mobile station of claim 15 further comprising:
an advertisement picker, coupled to the classifier, for receiving the class:keyword and the key-phrase from the classifier and retrieving at least an available advertisement from an advertisement database based on the class:keyword and the key-phrase.

20. The mobile station of claim 15 further comprising:
a transceiver, coupled to the association engine, for sending a request to the network for data and for receiving the data from the network.
